(19) United States
(12) Patent Application Publication
(10) Pub. No.: US 2002/0050346 A1
(43) Pub. Date: May 2, 2002

(54) Method of manufacturing a brazed-plate heat exchanger and exchanger thus produced

(75) Inventors: Jean-Claude Colin, Yerres (FR); Marc Wagner, Saint-Maur Des Fosses (FR)

Correspondence Address: YOUNG & THOMPSON, 745 SOUTH 23RD STREET 2ND FLOOR, ARLINGTON, VA, 22202

(73) Assignee: L'Air Liquide

(21) Appl. No.: 09/984,177

(22) Filed: Oct. 29, 2001

(30) Foreign Application Priority Data
Oct. 27, 2000 (FR) 00 13862

(51) Int. Cl. F28F 3/00; B23P 15/26; B23K 31/00

(52) U.S. Cl. 165/166; 29/890.054

(57) ABSTRACT

Method of manufacturing a plate heat exchanger of the type comprising a plurality of plates and possibly of separating elements, made of a brazable material, which define circuits for the circulation of fluids and are assembled to one another by brazing. The brazing takes place after the foils of brazing alloy have been deposited on the regions to be brazed. The foils and the regions to be brazed are co-rolled before the brazing. The invention is applicable to the reboiler-condensers of air separation plants.

The invention relates to the field of heat exchangers manufactured by assembling brazed plates.

The reboiler-condensers of air separation plants have, for several decades, generally been made of aluminium or of an aluminium alloy by means of plates brazed together. They may also be made of copper, nickel, stainless steel or any other brazable metal. These exchangers generally consist of two or more circuits defined by the configuration of the constituent plates and of possible elements separating the plates, such as heat-exchange fins, that the exchanger may contain. The various fluid circulation circuits are connected to the rest of the plant via a system of pipes welded to the exchanger.

Deposition of the material serving as the braze conventionally takes place by depositing a powder, wires or foils on those regions of the exchanger which are to be brazed. This deposition may be carried out either on the plates of the exchanger or on the heat-exchange fins. Given the number and the length of the regions to be brazed, the operation of depositing the brazing material is very expensive and not very reliable. In the case of powders, the problem arises as to their distribution over the brazing region. Moreover, in general the materials used for the braze are often noble alloys containing, for example, silver in large amount. Since these alloys are very expensive, it would be beneficial to minimize as far as possible the amount of brazing alloy used, without correspondingly compromising the quality of the brazing, which depends especially on the thickness uniformity of the alloy deposited.

From the latter standpoint, the method of depositing the brazing alloy in the form of foils is beneficial in that the thickness of the brazing material itself may be correctly controlled. However, after they have been deposited on the region to be brazed, these foils may exhibit corrugations and wrinkles which make the effectiveness of the braze random.

It is an object of the invention to provide a method of manufacturing plate heat exchangers by brazing, in which the brazing material is deposited on the form of foils, having better reliability than the methods of this type that are currently used.

For this purpose, the subject of the invention is a method of manufacturing a plate heat exchanger of the type comprising a plurality of plates and possibly of separating elements, made of a brazable material, which define circuits for the circulation of fluids and are assembled to one another by brazing, the said brazing taking place after foils of brazing alloy have been deposited on the regions to be brazed, characterized in that the said foils and the said regions to be brazed are co-rolled before the said brazing.

In a preferred example of how to implement this method, the said regions to be brazed are made of copper and the said foils are made of a copper-based alloy containing at least one of the elements chosen from silver, arsenic, manganese, tin, phosphorus, silicon, beryllium, tellurium and nickel.

The said foils preferably have a thickness of between 100 μm et 10 μm after the said co-rolling.

The said co-rolling may comprise a step of hot-rolling the said foils onto the said regions to be brazed and then possibly a cold-rolling step.

The material of the regions to be brazed and the material of the foils are, in this case, preferably capable of forming a solid solution.

In particular, the said regions to be brazed may be made of copper or a copper alloy and the said foils may be made of silver or a silver-based alloy.

The said co-rolling may also consist of cold rolling of the said foils onto the said regions to be brazed.

In this case, the said regions to be brazed may be made of copper or a copper alloy and the said foils may be composed of at least one of the elements chosen from arsenic, manganese, tin, phosphorus, silicon, beryllium, tellurium and nickel.

The method according to the invention may include the successive deposition of at least two foils of brazing material on the regions to be brazed, the said co-rolling being carried out after the last of the said foils has been deposited.

An intermediate co-rolling operation may be carried out after at least one of the said foils other than the last one has been deposited.

Prior to brazing, a heat treatment may be carried out in order to obtain diffusion between the said foils.

It is also possible to deposit, prior to the co-rolling, a pulverulent material between the plate of brazable material and the said foils and/or between the said successively deposited foils.

The subject of the invention is also a plate heat exchanger of the type comprising a plurality of plates and possibly of separating elements made of a brazable material which defines circuits for the circulation of fluid and assembled to one another by brazing, characterized in that it can be obtained by the above method.

As will have been understood, the invention essentially consists in co-rolling the foil or foils which have been deposited on the regions to be brazed, prior to the brazing operation itself. Thus, a layer of brazing material, the thickness of which is perfectly uniform and the adhesion of which to the region to be brazed is satisfactory at every point, is obtained. Thus, the quality of the brazed joint is optimized, as is the amount of brazing material used.

Preferably, the foils of brazing material are deposited on the plates of the exchanger. Deposition on the heat-exchange fins that the exchangers may have would be conceivable, but this would have to be carried out on both faces of the fins, and before they are formed. Thus, it would be necessary to use larger amounts of brazing material than in the case of deposition on the plates, and the deposition method would be more complex.

As constituent material of the plates of the exchanger, copper is a preferred example (in particular when it is in the annealed state), but other brazable metals which are good heat conductors that it is usual to employ for this purpose may also be suitable, namely aluminium, nickel or stainless steel for example.

As possible materials constituting the brazing material, silver, arsenic, copper, manganese, nickel, tin, phosphorus, silicon, beryllium and tellurium may be used. The foils of brazing material may consist of one of these elements in the virtually pure state, or of an alloy of two or more of these elements.

When it is desired to produce a brazing material containing several of the abovementioned elements, it is possible to deposit on the brazing region a single foil having directly the desired composition. However, it is also possible to deposit in succession, one on top of another, at least two foils of different compositions, the co-rolling taking place after the last foil has been deposited. As a variant, in addition to the final co-rolling, it is possible to carry out one or more intermediate co-rolling operations after at least one of the said foils other than the last one has been deposited.

If the brazing material is deposited as several successive layers, it is conceivable to carry out, after the co-rolling and before the brazing, a heat treatment whose purpose is to achieve partial or complete diffusion of the constituent elements of the foils into one another so as to obtain a more homogeneous brazing material before carrying out the brazing. However, although experience shows that a brazed joint of sufficient quality can be obtained without such a heat treatment, it Is of course possible to carry out the brazing directly after the co-rolling.

The co-rolling may be carried out by hot rolling, possibly followed by a cold-rolling operation, or it may be carried out by only cold rolling. Each of these rolling operations may be carried out in one or more passes, depending on the nature of the materials involved, their thicknesses and the characteristics of the rolling mill, in particular the forces that it is capable of applying to the materials.

Hot rolling has the advantage of providing some of the energy needed for the co-rolling in thermal form rather than in mechanical form, and therefore requires, in order to obtain a given thickness reduction, a rolling mill able to deliver lower mechanical forces than a cold-rolling mill. However, heating runs the risk of excessively accentuating any differences in behaviour between the various materials and there is a risk therefore of the quality of bonding between them not being optimum.

In general, the co-rolling by hot rolling (and then possibly cold rolling) is very suitable for materials which can form a solid solution. This is especially the case with copper or silver, for the brazing of which the invention is a preferred example of the application. Since silver and its alloys are an expensive brazing material, it is particularly beneficial by means of the method according to the invention to minimize the amount of it used. This is also the case with copper and nickel.

The materials which do not form a solid solution are, preferably, co-rolled by only cold rolling. This is the case, for example, with copper and tin, copper and phosphorus, etc.

Once the co-rolling and the possible heat treatment have been carried out and the exchanger assembled, the brazing is carried out by putting the exchanger in a furnace which heats it to a suitable temperature for carrying out the brazing, as is already known.

As an example, a copper baseplate 10 mm in thickness and two nickel foils 1 mm in thickness which sandwich it may be co-rolled at a temperature of 650 to 700° C. in order to obtain, by this single hot-co-rolling operation, a plate 1.2 mm in thickness ready to be brazed.

A baseplate made of annealed copper 2 mm in thickness and two foils of Cu-Ni-Sn-P alloy 0.15 mm in thickness which sandwich it may be co-rolled. This cold co-rolling is carried out at room temperature and a plate 0.8 mm in thickness ready to be brazed is obtained.

Finally, according to the invention., it is also possible to co-roll the baseplate and the foil of brazing material in the presence of an intermediate layer of a pulverulent material. The latter thus forms part of the composition of the final brazing material after the co-rolling.

As an example of this latter method of operation, a layer of nickel-phosphorus powder 70 μm in thickness and then a foil of copper-tin alloy 100 μm in thickness may be deposited on a baseplate of annealed copper 2 mm in thickness. The assembly is co-rolled at room temperature in order to obtain a plate 0.8 mm in thickness ready to be brazed.

When several foils of brazing alloy deposited in succession on the baseplate are used, it is conceivable to deposit pulverulent material between the said foils, in addition to or instead of depositing this material between the baseplate and the first foil.

The invention is applicable to any type of plate exchanger assembled by brazing, whatever its applications and its dimensions, the reboiler-condensers of air separation plants being merely a preferred application example.

1. Method of manufacturing a plate heat exchanger of the type comprising a plurality of plates and possibly of separating elements, made of a brazable material, which define circuits for the circulation of fluids and are assembled to one another by brazing, the said brazing taking place after the foils of brazing alloy have been deposited on the regions to be brazed, characterized in that the said foils and the said regions to be brazed are co-rolled before the said brazing

2. Method according to claim 1, characterized in that the said regions to be brazed are made of copper and the said foils are made of a copper-based alloy containing at least one of the elements chosen from silver, arsenic, manganese, tin, phosphorus, silicon, beryllium, tellurium and nickel.

3. Method according to claim 1 or 2, characterized in that the said foils have a thickness of between 100 μm and 10 μm after the said co-rolling.

4. Method according to one of claims 1 to 3, characterized in that the said co-rolling comprises a step of hot rolling the said foils onto the said regions to be brazed, and then possibly a cold-rolling step.

5. Method according to claim 4, characterized in that the material of the regions to be brazed and the material of the foils are capable of forming a solid solution.

6. Method according to claim 5, characterized in that the said regions to be brazed are made of copper or a copper alloy and in that the said foils are made of silver or a silver-based alloy.

7. Method according to claim 5, characterized in that the said regions to be brazed are made of copper or a copper alloy and in that the said foils are made of nickel or a nickel-based alloy.

8. Method according to one of claims 1 to 3, characterized in that the said co-rolling consists in cold-rolling the said foils onto the said regions to be brazed.

9. Method according to claim 8, characterized in that the said regions to be brazed are made of copper or a copper alloy and the said foils are composed of at least one of the elements chosen from arsenic, manganese, tin, phosphorus, silicon, beryllium, tellurium and nickel.

10. Method according to one of claims 1 to 9, characterized in that it comprises the successive deposition of at least two foils of brazing material on the regions to be brazed, the said co-rolling being carried out after the last of the said foils has been deposited.

11. Method according to claim 10, characterized in that an intermediate co-rolling operation is carried out after at least one of the said foils other than the last one has been deposited.

12. Method according to claim 10 or 11, characterized in that, prior to brazing, a heat treatment is carried out in order to obtain diffusion between the said foils.

13. Method according to one of claims 1 to 12, characterized in that the said foils are deposited on the plates of the exchanger.

14. Method according to one of claims 1 to 12, characterized in that, prior to the co-rolling, a pulverulent material is deposited between the plate of brazable material and the said foils, and/or between the said foils deposited in succession.

15. Plate heat exchanger of the type comprising a plurality of plates and possibly of separating elements made of a brazable material which defines circuits for the circulation of fluids and are assembled to one another by brazing, characterized in that it can be obtained by the method according to one of claims 1 to 14.
